(19) United States
(12) Patent Application Publication
(10) Pub. No.: US 2019/0128707 A1
(43) Pub. Date: May 2, 2019

(54) Optical Scale, Encoder, Robot, Electronic-Component Conveying Apparatus, Printer, And Projector

(71) Applicant: Seiko Epson Corporation, Tokyo (JP)

(72) Inventors: Akio KONISHI, Matsumoto (JP); Fuyumi TAKATA, Azumino (JP); Noboru FURUYA, Chino (JP)

(21) Appl. No.: 16/173,253

(22) Filed: Oct. 29, 2018

(30) Foreign Application Priority Data
Oct. 30, 2017 (JP) 2017-209300

(51) Int. Cl. G01D 5/347; G01B 11/00; G06T 7/00

(52) U.S. Cl. CPC G01D 5/34715; G01B 11/002; G06T 2207/10016; G06T 2207/30164; G06T 2207/20104; G06T 7/0004

(57) ABSTRACT

An optical scale includes a tabular base material and an optical pattern provided above a principal plane of the base material and including a first region where a resin layer including photosensitive resin is formed and a second region where the resin layer is not formed. The optical pattern includes a pigment.

### BACKGROUND

### 1. Technical Field

The present invention relates to an optical scale, an encoder, a robot, an electronic-component conveying apparatus, a printer, and a projector.

### 2. Related Art

For example, in apparatuses such as a robot and a handler (an electronic-component conveying apparatus) that perform operation on the basis of an imaging result of a camera, in general, calibration (position correction) of a camera coordinate is performed. As a method of such calibration, for example, a technique described in JP-A-2013-68617 (Patent Literature 1) is known. In the technique described in Patent Literature 1, a scale is imaged by a camera and a pattern in the scale is recognized to perform position correction. In the past, the scale used in such a configuration was created by forming a mark on a ceramic substrate with printing or the like.

In the scale in the past, the mark (a pattern) is formed by the printing or the like. Therefore, it is difficult to sufficiently improve dimension accuracy.

### SUMMARY

An advantage of some aspects of the invention is to provide an optical scale that can improve dimension accuracy of an optical pattern and to provide an encoder, a robot, an electronic-component conveying apparatus, a printer, and a projector including the optical scale.

The invention can be implemented as the following application examples or forms.

An optical scale according to an application example includes: a tabular base material; and an optical pattern provided on a principal plane of the base material and including a first region where a resin layer including photosensitive resin is formed and a second region where the resin layer is not formed.

With such an optical scale, because the optical pattern includes the first region and the second region distinguished by presence or absence of the resin layer including the photosensitive resin, dimension accuracy of the optical pattern can be improved.

In the optical scale according to the application example, it is preferable that the optical pattern is provided on both of a first principal plane and a second principal plane of the base material.

With this configuration, it is possible to realize the optical scale in which a positional relation between the optical patterns on both the planes is highly accurately determined.

In the optical scale according to the application example, it is preferable that the base material includes a silicon substrate.

With this configuration, it is possible to highly accurately manufacture, with high productivity, the base material having high dimension accuracy using a semiconductor process technique and highly accurately form positioning holes or the like in the base material. The silicon substrate is inexpensive compared with a ceramic substrate. A reduction in the cost of the optical scale can be achieved. Further, because the silicon substrate has an extremely small coefficient of thermal expansion, by using the silicon substrate as the base material of the optical scale, it is possible to realize the optical scale having a small error due to a temperature change.

In the optical scale according to the application example, it is preferable that the base material includes a quartz substrate.

With this configuration, it is possible to highly accurately manufacture, with high productivity, the base material having high dimension accuracy using the semiconductor process technique and highly accurately form positioning holes or the like in the base material. The quartz substrate (a crystal substrate) is inexpensive compared with the ceramic substrate. A reduction in the cost of the optical scale can be achieved. Further, because the quartz substrate has an extremely small coefficient of thermal expansion, by using the quartz substrate as the base material of the optical scale, it is possible to realize an optical scale having a small error due to a temperature change.

In the optical scale according to the application example, it is preferable that the resin layer includes a pigment.

With this configuration, it is possible to easily realize an optical pattern having a desired optical characteristic (e.g., contrast at the time of imaging by a camera).

In the optical scale according to the application example, it is preferable that thickness of the resin layer is 1 μm or more and 10 μm or less.

With this configuration, it is possible to easily realize an optical pattern having high dimension accuracy and a desired optical characteristic.

An encoder according to an application example includes: the optical scale according to the application example explained above; and an imaging section configured to image the optical pattern.

With such an encoder, because dimension accuracy of the optical pattern of the optical scale is high, detection accuracy of the encoder can be improved.

A robot according to an application example includes the optical scale according to the application example explained above.

With such a robot, it is possible to improve characteristics of the robot making use of an effect of the optical scale.

An electronic-component conveying apparatus according to an application example includes the optical scale according to the application example explained above.

With such an electronic-component conveying apparatus, it is possible to improve characteristics of the electronic-component conveying apparatus making use of the effect of the optical scale.

A printer according to an application example includes the optical scale according to the application example explained above.

With such a printer, it is possible to improve characteristics of the printer making use of the effect of the optical scale.

A projector according to an application example includes the optical scale according to the application example explained above.

With such a projector, it is possible to improve characteristics of the projector making use of the effect of the optical scale.

### BRIEF DESCRIPTION OF THE DRAWINGS

The invention will be described with reference to the accompanying drawings, wherein like numbers reference like elements.

FIG. 1 is a plan view showing an optical scale according to an embodiment of the invention.

FIG. 2 is a partially enlarged sectional view of the optical scale shown in FIG. 1.

FIG. 3 is a schematic diagram showing an encoder according to the embodiment.

FIG. 4 is a perspective view showing an electronic-component conveying apparatus according to the embodiment.

FIG. 5 is a perspective view showing a robot according to the embodiment.

FIG. 6 is a perspective view showing a printer according to the embodiment.

FIG. 7 is a schematic diagram showing a projector according to the embodiment.

### DESCRIPTION OF EXEMPLARY EMBODIMENTS

A preferred embodiment of the invention is explained below with reference to the accompanying drawings.

### 1. Optical Scale

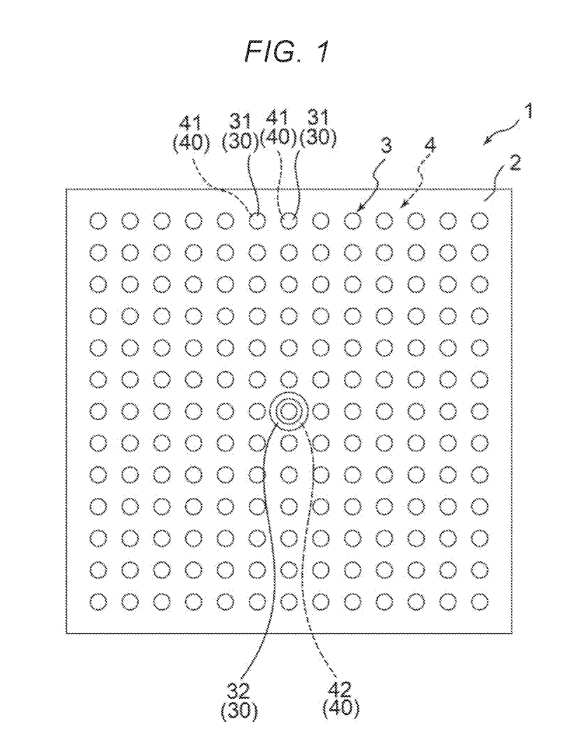

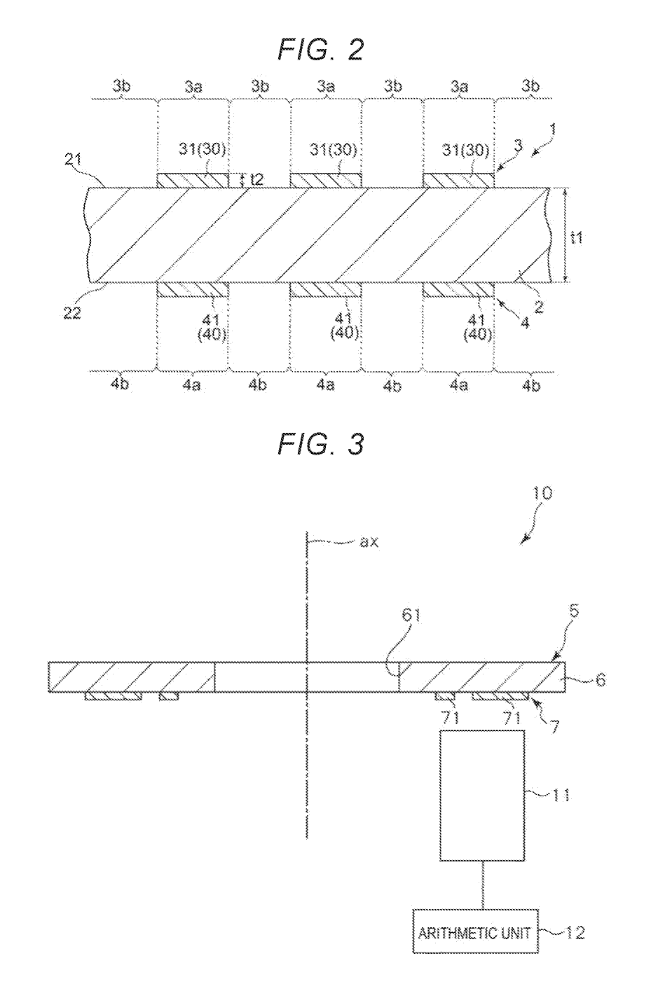

FIG. 1 is a plan view showing an optical scale according to an embodiment of the invention. FIG. 2 is a partially enlarged sectional view of the optical scale shown in FIG. 1.

An optical scale 1 shown in FIG. 1 is a member for calibration used for calibration of a camera coordinate (a coordinate set in a captured image of an imaging device). The optical scale 1 includes, as shown in FIGS. 1 and 2, a tabular base material 2, an optical pattern 3 disposed on one surface 21 (on the upper side in FIG. 2) (a first principal plane) of the base material 2, and an optical pattern 4 disposed on the other surface 22 (on the lower side in FIG. 2) (a second principal plane) of the base material 2.

The surfaces 21 and 22 of the base material 2 configure second regions 3b and 4b of optical patterns 3 and 4 explained below. Therefore, the surfaces 21 and 22 of the base material 2 (two plate surfaces included in the base material 2) are respectively configured such that the optical patterns 3 and 4 are reflected at satisfactory contrast in a captured image obtained by imaging the optical patterns 3 and 4 with a camera. When resin layers 30 and (first regions 3a and 4a) of the optical patterns 3 and explained below are configured to irregularly reflect light, it is desirable that the surfaces 21 and 22 of the base material 2 respectively resemble a mirror surface as closely as possible, that is, are formed as smooth surfaces. Consequently, it is possible to increase the contrast of the optical patterns 3 and 4 imaged by the camera. Note that, when one of the optical patterns 3 and 4 is not used, the surface on a side in use of the base material 2 only has to be formed as the smooth surface.

A constituent material of the base material 2 is not particularly limited. Examples of the constituent material include single crystal silicon, silicon carbide, and quartz (crystal). It is desirable to use the single crystal silicon or the quartz. That is, it is desirable that the base material 2 includes a silicon substrate or a quartz substrate. Consequently, it is possible to highly accurately manufacture, with high productivity, the base material 2 having high dimension accuracy using a semiconductor process technique such as etching or photolithography and highly accurately form positioning holes or the like in the base material 2. The silicon substrate or the quartz substrate is inexpensive compared with a ceramic substrate. A reduction in the cost of the optical scale 1 can be achieved. Further, because the silicon substrate or the quartz substrate has an extremely small coefficient of thermal expansion (silicon: 3.9×10⁻⁶/° C., quartz: 0.5×10⁻⁶/° C.), the optical scale 1 having a small error due to a temperature change can be realized by using the silicon substrate or the quartz substrate as the base material 2 of the optical scale 1. Note that the base material 2 may be configured by only the substrate explained above or a metal film such as an aluminum film, an optical thin film, or the like may be provided on at least one surface of the substrate. Thickness t1 of the base material 2 is not particularly limited. The thickness t1 is, for example, approximately 0.05 mm or more and 2 mm or less.

The optical pattern 3 includes, as shown in FIG. 1, a first region 3a where a resin layer 30 including photosensitive resin is formed and a second region 3b where the resin layer 30 is not formed. Similarly, the optical pattern 4 includes a first region 4a where a resin layer 40 including photosensitive resin is formed and a second region 4b where the resin layer 40 is not formed.

As shown in FIG. 1, the resin layer 30 is patterned to include a plurality of dot-like marks 31 arranged in a matrix shape and a ring-like mark 32 for identifying the mark 31 located in the center among the plurality of marks 31. Similarly, the resin layer 40 is patterned to include a plurality of dot-like marks 41 arranged in a matrix shape and a ring-like mark 42 for identifying the mark 41 located in the center among the plurality of marks 41. Such optical patterns 3 and 4 overlap to coincide with each other in the same shape and the same size when viewed from the thickness direction of the base material 2. Consequently, the optical patterns 3 and 4 have a predetermined positional relation with each other. Note that the shape of the optical patterns 3 and 4 is an example. The optical patterns 3 and 4 only have to be patterns usable for calibration of a camera coordinate. The shape of the optical patterns 3 and 4 is not limited to the shape shown in FIG. 1 and is optional.

In this way, the optical patterns 3 and 4 are provided on both of the first principal plane (the surface 21) and the second principal plane (the surface 22) of the base material 2. Consequently, it is possible to realize the optical scale 1 in which a positional relation between the optical patterns 3 and 4 on both the surfaces is highly accurately determined. Note that one of the optical patterns 3 and 4 may be omitted depending on a method of use of the optical scale 1.

The resin layers 30 and 40 of the optical patterns 3 and 4 respectively include photosensitive resin. Consequently, the resin layers 30 and 40 (the first regions 3a and 4a) can be formed by a photolithography method. Therefore, dimension accuracy of the optical patterns 3 and 4 can be improved. In this embodiment, by using a double-side aligner when forming the optical patterns 3 and 4, alignment of the optical pattern 3 and the optical pattern 4 can also be highly accurately performed (with an error of ±2 μm or less).

Such photosensitive resin is not particularly limited. Examples of the photosensitive resin include polyimide resin and epoxy resin having photosensitivity and copolymer of the polyimide resin and the epoxy resin. Such photosensitive resin may be either a positive type or a negative type. However, the photosensitive resin is desirably the negative type. Consequently, compared with when the photosensitive resin is the positive type, the optical patterns 3 and 4 can be easily highly accurately formed.

It is desirable that the resin layers 30 and 40 include a pigment besides the photosensitive resin explained above. Consequently, it is possible to easily realize the optical patterns 3 and 4 having a desired optical characteristic (e.g., contrast at the time of imaging by a camera). Such a pigment is not particularly limited and only has to have a light blocking property and a light scattering property. A white pigment such as titanium dioxide or zinc oxide is desirably used. Consequently, when the plate surface of the base material 2 is a mirror surface, the optical patterns 3 and 4 (the resin layers 30 and 40) can be imaged by the camera at extremely satisfactory contrast. A content of the pigment in the resin layers 30 and 40 is not particularly limited but is desirably 10 mass % or more and 30 mass % or less. Consequently, it is possible to exert the light blocking property and the light scattering property explained above while reducing the thickness of the resin layers 30 and 40. Note that the constituent material of the resin layers 30 and 40 may include, for example, a filler and various additives besides the photosensitive resin and the pigment explained above.

Thickness t2 of each of the resin layers 30 and is desirably 1 μm or more and 10 μm or less, more desirably 2 μm or more and 8 μM or less, and still more desirably 3 μm or more and 5 μm or less. Consequently, it is possible to easily realize the resin layers 30 and 40 (the optical patterns 3 and 4) having high dimension accuracy and a desired optical characteristic. On the other hand, when the thickness t2 is too small, light is easily transmitted through the resin layers 30 and 40 depending on presence or absence of the pigment in the resin layers 30 and 40 or the content of the pigment. As a result, the contrast of the optical patterns 3 and 4 imaged by the camera shows a decreasing tendency. On the other hand, when the thickness t2 is too large, because an exposure time increases, corner portions formed by the surfaces and the side surfaces of the resin layers 30 and 40 are easily rounded depending on, for example, a type of the photosensitive resin. As a result, the dimension accuracy of the optical patterns 3 and 4 shows a decreasing tendency.

The optical scale 1 explained above can be manufactured, for example, as explained below. First, a silicon substrate is prepared. Grinding or CMP (chemical mechanical polishing) is performed according to necessity to form the silicon substrate in desired thickness. Consequently, the silicon substrate, both the surfaces of which are mirror surfaces, is obtained. Subsequently, photosensitive resin (a resist material) is patterned on both the surfaces of the silicon substrate by the photolithography method to form the optical patterns 3 and (the resin layers 30 and 40). Thereafter, unnecessary portions of the silicon substrate are removed by dicing, inductively coupled plasma (ICP), laser machining, etching (e.g., a Bosch process), or the like to obtain the base material 2. The optical scale 1 can be obtained in this way.

As explained above, the optical scale 1 includes the tabular base material 2 and the optical patterns 3 and 4 provided on the principal planes of the base material and including the first regions 3a and 4a where the resin layers 30 and 40 including the photosensitive resin are formed and the second regions 3b and 4b where the resin layers 30 and 40 are not formed. With such an optical scale 1, the optical patterns 3 and 4 include the first regions 3a and 4a and the second regions 3b and 4b distinguished by the presence or absence of the resin layers 30 and 40 including the photosensitive resin. Therefore, the dimension accuracy of the optical patterns 3 and 4 can be improved.

In particular, when the optical patterns 3 and 4 include the pigment besides the photosensitive resin, the contrast of the optical patterns 3 and 4 imaged by the camera can be increased. Note that, for example, when an imaging region of the camera is illuminated by oblique illumination, even if the optical patterns 3 and 4 are covered by a transparent resin layer or inorganic layer, the contrast of the optical patterns 3 and 4 imaged by the camera can be increased.

### 2. Encoder

FIG. 3 is a schematic diagram showing an encoder according to the embodiment.

An encoder 10 shown in FIG. 3 is an optical rotary encoder. The encoder 10 detects turning states of two members (not shown in FIG. 3) turnable with respect to each other around a turning axis ax. The encoder 10 includes an optical scale 5 provided in one of the two members, a camera (an imaging section) provided in the other of the two members, and an arithmetic unit 12 connected to the camera 11.

The optical scale 5 is a scale for the optical encoder. The optical scale 5 includes a tabular base material 6 and an optical pattern 7 disposed on one surface (on the lower side in FIG. 3) of the base material 6.

The base material 6 is configured the same as the base material 2 of the optical scale 1 explained above except that a plan-view shape is different. The base material 6 is formed in a disk shape. The base material has a disc shape and a hole 61 piercing through the base material 6 in the thickness direction is provided in the center of the base material 6. The hole 61 can be used to fix the base material 6 to one of the two members.

The optical pattern 7 is configured using photosensitive resin in the same manner as the optical patterns 3 and 4 of the optical scale 1 explained above except that a pattern shape is different. The optical pattern 7 includes a plurality of marks 71 different from one another capable of identifying positions different from one another in the circumferential direction of the optical scale 5. The plurality of marks 71 are not particularly limited. Examples of the plurality of marks 71 include numbers, characters such as Roman characters, Arabic characters, and Chinese characters, signs, marks, symbols, emblems, designs, one-dimensional barcodes, QR codes (registered trademark) and irregularly arranged dots and lines other than the characters.

In this way, the optical scale 5 includes the tabular base material 6 and the optical pattern 7 provided on at least one surface (in this embodiment, the surface on one side) of the base material 6 and configured using the photosensitive resin. With such an optical scale 5, although not shown in FIG. 3, the optical pattern 7 includes a first region and a second region distinguished by presence or absence of a resin layer including the photosensitive resin. Therefore, the dimension accuracy of the optical pattern 7 can be improved.

Although not shown in FIG. 3, the camera 11 includes an imaging device such as a CCD (Charge Coupled Devices) or a CMOS (Complementary Metal Oxide Semiconductor) and an imaging optical system such as a telecentric optical system. The imaging device images the optical pattern 7 of the optical scale 5 via the imaging optical system.

In the camera 11, a light source that illuminates an imaging region may be provided according to necessity. In this case, the light source may be coaxial epi-illumination or may be oblique illumination.

The arithmetic unit 12 estimates turning states such as a tuning angle, turning speed, and a turning direction of a detection target on the basis of a captured image of the camera 11. A method of the estimation is not particularly limited. Examples of the method include a method in which template matching is used. Such an arithmetic unit 12 is configured by, for example, an ASIC (application specific integrated circuit) or an FPGA (field-programmable gate array). Although not shown in FIG. 12, the arithmetic unit 12 includes a processor such as a CPU (Central Processing Unit) and a memory such as a ROM (Read Only Memory) or a RAM (Random Access Memory). The processor reads and executes a computer program stored in the memory as appropriate to realize the function explained above.

As explained above, the encoder 10 includes the optical scale 5 and the camera 11, which is an imaging section configured to image the optical pattern 7 of the optical scale 5. With such an encoder 10, the dimension accuracy of the optical pattern 7 of the optical scale 5 is high as explained above. Therefore, the detection accuracy of the encoder 10 can be improved.

### 3. Electronic-Component Conveying Apparatus

An electronic-component conveying apparatus according to the embodiment is explained.

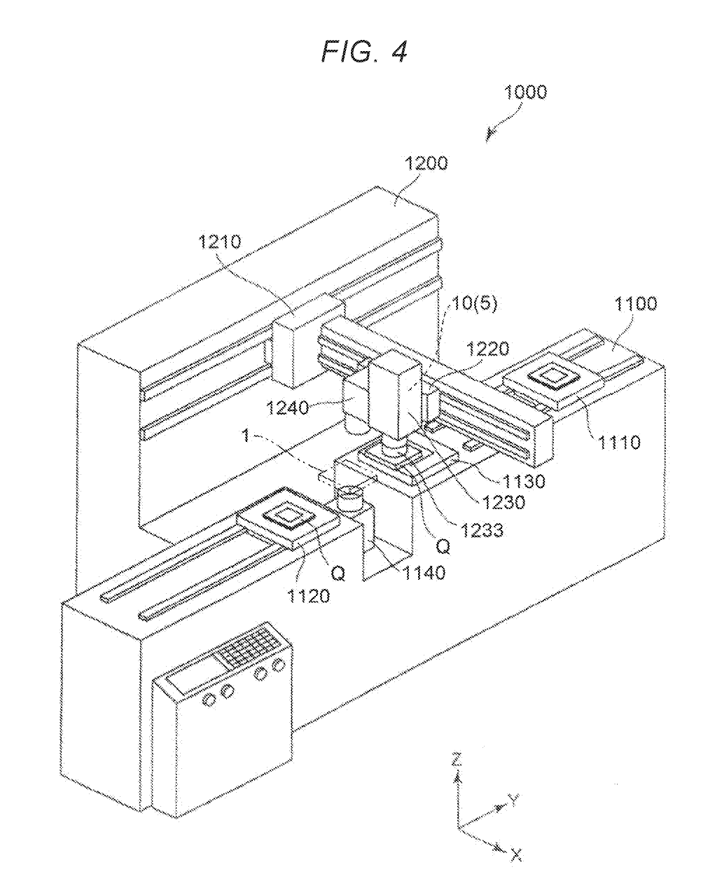

FIG. 4 is a perspective view showing the electronic-component conveying apparatus according to the embodiment. Note that, in the following explanation, for convenience of explanation, an X axis, a Y axis, and a Z axis, which are three axes orthogonal to one another, are used for the explanation.

An electronic-component conveying apparatus 1000 shown in FIG. 4 is applied to an electronic-component inspecting apparatus. The electronic-component conveying apparatus 1000 includes a base 1100 and a supporting table 1200 disposed on a side of the base 1100.

In the base 1100, an upstream-side stage 1110 on which an inspection target electronic component Q is placed and conveyed in the Y-axis direction, a downstream-side stage 1120 on which an inspected electronic component Q is placed and conveyed in the Y-axis direction, and an inspection table 1130 located between the upstream-side stage 1110 and the downstream-side stage 1120 and used to inspect an electric characteristic of the electronic component Q are provided. A camera 1140 for confirming a posture of the electronic component Q is provided between the upstream-side stage 1110 and the downstream-side stage 1120 of the base 1100. Note that examples of the electronic component Q include a semiconductor, a semiconductor wafer, a display device such as a CLD or an OLED, a crystal device, various sensors, an inkjet head, and various MEMS devices.

On the supporting table 1200, a Y stage 1210 movable in the Y-axis direction with respect to the supporting table 1200 is provided. On the Y stage 1210, an X stage 1220 movable in the X-axis direction with respect to the Y stage 1210 is provided. On the X stage 1220, a camera 1240 and an electronic-component holding section 1230 movable in the Z-axis direction with respect to the X stage 1220 are provided.

The electronic-component holding section 1230 includes a holding section 1233 configured to hold the electronic component Q. The electronic-component holding section 1230 is configured to be capable of finely adjusting positions in the X-axis direction and the Y-axis direction and a posture around the Z axis of the holding section 1233. The electronic-component holding section 1230 includes an encoder 10 configured to detect the posture around the Z axis of the holding section 1233.

The electronic-component conveying apparatus 1000 having such a configuration images, with the cameras 1140 and 1240, both surfaces of the optical scale 1 placed above the camera 1140 using a jig (not shown in FIG. 4) and performs calibration of the cameras 1140 and 1240 using a result of the imaging. In the cameras 1140 and 1240, light sources that illuminate an imaging region may be provided according to necessity. In this case, the light sources may be coaxial epi-illumination or may be oblique illumination.

As explained above, the electronic-component conveying apparatus 1000 includes the optical scales 1 and 5. With such an electronic-component conveying apparatus 1000, it is possible to improve characteristics of the electronic-component conveying apparatus 1000 making use of the effects of the optical scales 1 and 5.

### 4. Robot

A robot according to the embodiment is explained below with reference to an single-arm robot as an example.

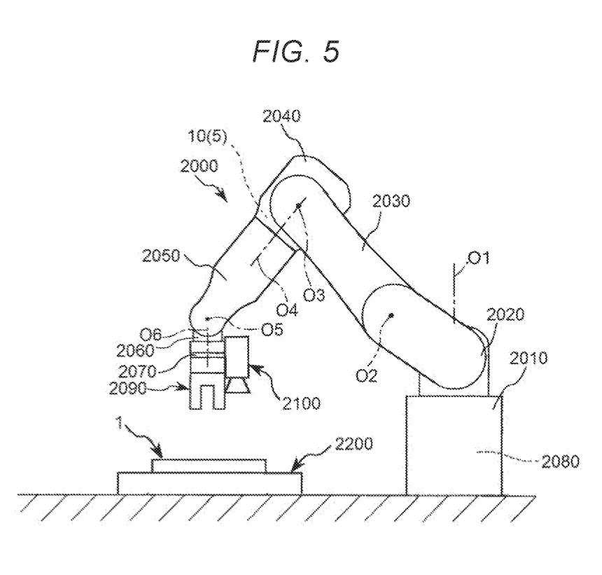

FIG. 5 is a perspective view showing the robot according to the embodiment.

A robot 2000 shown in FIG. 5 can perform work such as supply, removal, conveyance, and assembly of a precision instrument and components configuring the precision instrument (target objects). The robot 2000 is a six-axis robot. The robot 2000 includes a base 2010 fixed to a floor or a ceiling, an arm 2020 coupled to the base 2010 turnably around a turning axis O1, an arm 2030 coupled to the arm 2020 turnably around a turning axis O2, an arm 2040 coupled to the arm 2030 turnably around a tuning axis O3, an arm 2050 coupled to the arm 2040 turnably around a turning axis O4, an arm 2060 coupled to the arm 2050 turnably around a turning axis O5, an arm 2070 coupled to the arm 2060 turnably around a turning axis O6, and a control section 2080 configured to control driving of the arms 2020, 2030, 2040, 2050, 2060, and 2070. An end effector 2090 corresponding to work to be executed by the robot 2000 is attached to the distal end portion of the arm 2070. A camera 2100 is attached to a side surface of the arm 2070.

The encoder 10 is mounted on all or a part of a plurality of joint sections included in the robot 2000. The control section 2080 controls driving of the joint section on the basis of an output of the encoder 10. The control section 2080 can also control driving of the joint section on the basis of a captured image of the camera 2100. Note that, in FIG. 5, the encoder 10 is provided in a joint section between the arm 2040 and the arm 2050.

The robot 2000 having such a configuration images, with the camera 2100, the optical scale 1 placed on a workbench 2200 and performs calibration of the camera 2100 using a result of the imaging. A light source that illuminates an imaging region may be provided in the camera 2100 according to necessity. In this case, the light source may be coaxial epi-illumination or may be oblique illumination.

As explained above, the robot 2000 includes the optical scales 1 and 5. With such a robot 2000, it is possible to improve characteristics of the robot 2000 making use of the effects of the optical scales 1 and 5.

Note that the number of arms included in the robot 2000 is six in FIG. 5. However, the number of arms is not limited to this and may be one to five or seven or more.

### 5. Printer

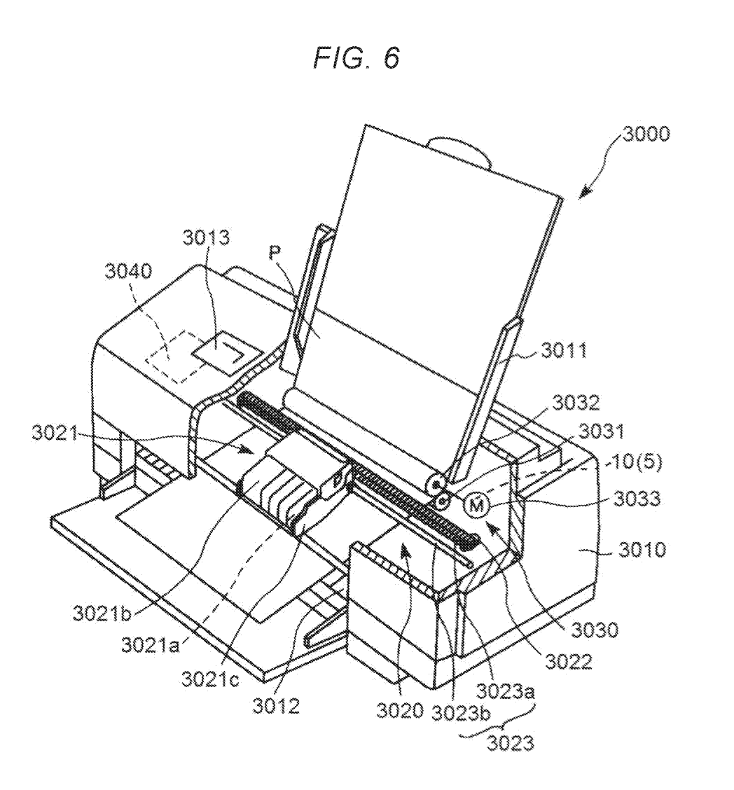

FIG. 6 is a perspective view showing a printer according to the embodiment.

A printer 3000 shown in FIG. 6 is a printer of an inkjet recording type. The printer 3000 includes an apparatus body 3010 and a printing mechanism 3020, a paper feeding mechanism 3030, and a control section 3040 provided on the inside of the apparatus body 3010.

In the apparatus body 3010, a tray 3011 in which recording sheets P are set, a paper discharge port 3012 for discharging the recording sheets P, and an operation panel 3013 such as a liquid crystal display are provided.

The printing mechanism 3020 includes a head unit 3021, a carriage motor 3022, and a reciprocating mechanism 3023 configured to reciprocate the head unit 3021 with a driving force of the carriage motor 3022. The head unit 3021 includes a head 3021a, which is an inkjet recording head, an ink cartridge 3021b configured to supply ink to the head 3021a, and a carriage 3021c mounted with the head 3021a and the ink cartridge 3021b. The reciprocating mechanism 3023 includes a carriage guide shaft 3023a configured to support the carriage 3021c to be capable of reciprocating and a timing belt 3023b for moving the carriage 3021c on the carriage guide shaft 3023a with a driving force of the carriage motor 3022.

The paper feeding mechanism 3030 includes a driven roller 3031 and a driving roller 3032 that are in pressed contact with each other, a paper feeding motor 3033 configured to drive the driving roller 3032, and the encoder 10 configured to detect a rotation state of a rotating shaft of the paper feeding motor 3033.

The control section 3040 controls the printing mechanism 3020, the paper feeding mechanism 3030, and the like on the basis of printing data input from a host computer such as a personal computer.

In such a printer 3000, the paper feeding mechanism 3030 intermittently feeds the recording sheets P one by one to the vicinity of a lower part of the head unit 3021. At this time, the head unit 3021 reciprocates in a direction substantially orthogonal to a feeding direction of the recording sheet P. Printing on the recording sheet P is performed.

As explained above, the printer 3000 includes the optical scale 5. With such a printer 3000, it is possible to improve characteristics of the printer 3000 making use of the effect of the optical scale 5.

### 6. Projector

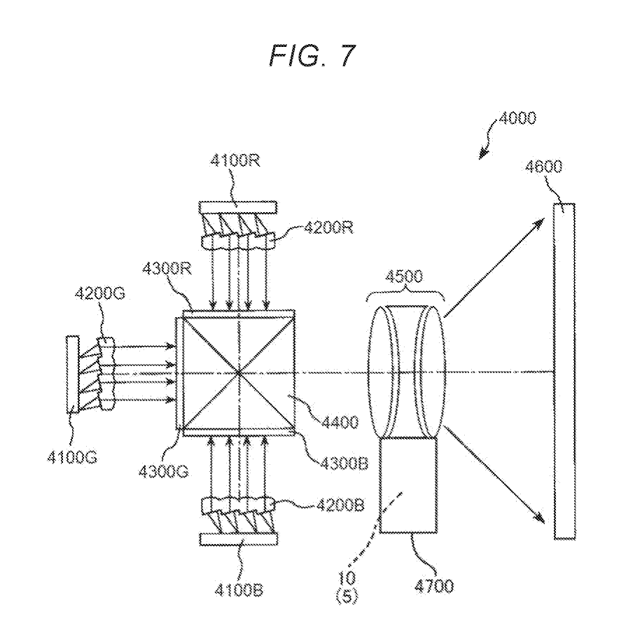

FIG. 7 is a schematic diagram showing a projector according to the embodiment.

A projector 4000 shown in FIG. 7 includes a light source 4100R configured to emit red light, a light source 4100G configured to emit green light, a light source 4100B configured to emit blue light, lens arrays 4200R, 4200G, and 4200B, liquid crystal light valves (light modulating sections) 4300R, 4300G, and 4300B of a transmission type, a cross dichroic prism 4400, a projection lens (a projecting section) 4500, and a piezoelectric driving device 4700.

Lights emitted from the light sources 4100R, 4100G, and 4100B are made incident on the liquid crystal light valves 4300R, 4300G, and 4300B via the lens arrays 4200R, 4200G, and 4200B. The liquid crystal light valves 4300R, 4300G, and 4300B respectively modulate the incident lights according to image information.

Three color lights modulated by the liquid crystal light valves 4300R, 4300G, and 4300B are made incident on the cross dichroic prism 4400 and combined. Light combined by the cross dichroic prism 4400 is made incident on the projection lens 4500, which is a projection optical system. The projection lens 4500 enlarges an image formed by the liquid crystal light valves 4300R, 4300G, and 4300B and projects the image onto a screen (a display surface) 4600. Consequently, a desired video is projected on the screen 4600. The projection lens 4500 is supported by the piezoelectric driving device 4700. A change (positioning) of a position and a posture is enabled by driving of the piezoelectric driving device 4700. Consequently, a shape, a size, and the like of the video projected on the screen 4600 can be adjusted. The piezoelectric driving device 4700 includes the encoder 10 for detecting a driving state of the piezoelectric driving device 4700.

Note that, in the example explained above, the liquid crystal light valve of the transmission type is used as the light modulating section. However, a light valve other than the liquid crystal light valve may be used or a light valve of a reflection type may be used. Examples of such a light valve include a liquid crystal light valve of a reflection type and a digital micromirror device. The configuration of the projection optical system is changed as appropriate according to a type of a light valve in use. The projector may be a projector of a scanning type that scans light on a screen to thereby display an image having a desired size on a display surface.

As explained above, the projector 4000 includes the optical scale 5. With such a projector 4000, it is possible to improve characteristics of the projector 4000 making use of the effect of the optical scale 5.

The embodiment of the invention is explained above with reference to the drawings. However, the invention is not limited to the embodiment. The components of the sections can be replaced with any components having the same functions. Any other components may be added.

In the invention, any two or more configurations (characteristics) in the embodiment may be combined.

The robot according to the embodiment is not limited to the single-arm robot as long as the robot includes arms and may be other robots such as a double-arm robot and a SCARA robot.

In the embodiment, the configuration is explained in which the optical scale and the encoder are applied to the electronic-component conveying apparatus, the robot, the printer, and the projector. However, the optical scale and the encoder can be applied to various electronic apparatuses other than these apparatuses as well. When the encoder is used in the printer, the encoder is not limited to the driving source of the paper feeding roller of the printer. The encoder can also be applied to, for example, a driving source of an inkjet head of the printer.

In the embodiment explained above, the optical scale according to the embodiment is applied to the scale for camera calibration and the scale for optical encoder. However, the invention can be applied to other various optical scales as well if the optical scales are imaged by a camera (an imaging device). The optical scale according to the embodiment is not limited to the optical scale for the rotary encoder. The optical scale is applicable to an optical scale for a linear encoder as well.

The entire disclosure of Japanese Patent Application No. 2017-209300, filed Oct. 30, 2017 is expressly incorporated by reference herein.

What is claimed is:

1. An optical scale comprising:
a tabular base material; and
an optical pattern provided above a principal plane of the base material and including a first region where a resin layer including photosensitive resin is formed and a second region where the resin layer is not formed.

2. The optical scale according to claim 1, wherein the optical pattern is provided on both of a first principal plane and a second principal plane of the base material.

3. The optical scale according to claim 1, wherein the base material includes a silicon substrate.

4. The optical scale according to claim 1, wherein the base material includes a quartz substrate.

5. The optical scale according to claim 1, wherein the resin layer includes a pigment.

6. The optical scale according to claim 1, wherein thickness of the resin layer is 1 μm or more and 10 μm or less.

7. An encoder comprising:
the optical scale according to claim 1; and
an imaging section configured to image the optical pattern.

8. An encoder comprising:
the optical scale according to claim 2; and
an imaging section configured to image the optical pattern.

9. An encoder comprising:
the optical scale according to claim 3; and
an imaging section configured to image the optical pattern.

10. A robot comprising the optical scale according to claim 1.

11. A robot comprising the optical scale according to claim 2.

12. A robot comprising the optical scale according to claim 3.

13. An electronic-component conveying apparatus comprising the optical scale according to claim 1.

14. An electronic-component conveying apparatus comprising the optical scale according to claim 2.

15. An electronic-component conveying apparatus comprising the optical scale according to claim 3.

16. A printer comprising the optical scale according to claim 1.

17. A printer comprising the optical scale according to claim 2.

18. A printer comprising the optical scale according to claim 3.

19. A projector comprising the optical scale according to claim 1.

20. A projector comprising the optical scale according to claim 2.
